(19) United States
(12) Patent Application Publication
(10) Pub. No.: US 2010/0332552 A1
(43) Pub. Date: Dec. 30, 2010

(54) Method and System for Generating Fused and Exploited Image Products

(75) Inventor: James E. Taber, Plano, TX (US)

Correspondence Address: BAKER BOTTS LLP, 2001 ROSS AVENUE, 6TH FLOOR, DALLAS, TX, 75201-2980, US

(73) Assignee: Raytheon Company, Waltham, MA (US)

(21) Appl. No.: 12/493,888

(22) Filed: Jun. 29, 2009

(51) Int. Cl. G06F 17/00

(52) U.S. Cl. 707/802; 707/803; 707/915

(57) ABSTRACT

According to one embodiment, a computer-readable medium having computer-executable instructions, when executed by a computer is configured to request a National Imagery Transmission Format (NITF) file. The NITF file comprises a geo-spatially enabled image, associated metadata, and text annotations. A plurality of graphical overlays are retrieved from a metadata repository. The plurality of graphical overlays comprise additional metadata associated with the geo-spatially enabled image. Text annotations are extracted from the geo-spatially enabled image. A skeleton Keyhole Markup Language (KML) file is created. Metadata overlays for each type of metadata and text annotations are added to the skeleton KML file. Overlays for the text annotations are added to the skeleton KML file. An image overlay for the geo-spatially enabled image is added to the skeleton KML file. The skeleton KML file and all files associated with the metadata overlays and annotations are zipped into a zipped KML (KMZ) file. The KMZ file is uploaded to a discoverable data store.

### TECHNICAL FIELD

This invention relates generally to the field of image systems and more specifically to a method and system for generating fused and exploited image products.

### BACKGROUND

Image systems may reference a variety of data types, such as digital-imagery products and image-related data. Image systems may include mechanisms for the exchange, storage, annotation, and transmission of digital-imagery products and image-related products. Multiple data types, such as digital-imagery products and image-related products, may be combined to form a fused and exploited image product.

### SUMMARY OF THE DISCLOSURE

According to one embodiment, a computer-readable medium having computer-executable instructions, when executed by a computer is configured to request a National Imagery Transmission Format (NITF) file. The NITF file comprises a geo-spatially enabled image, associated metadata, and text annotations. A plurality of graphical overlays are retrieved from a metadata repository. The plurality of graphical overlays comprise additional metadata associated with the geo-spatially enabled image. Text annotations are extracted from the geo-spatially enabled image. A skeleton Keyhole Markup Language (KML) file is created. Metadata overlays for each type of metadata and text annotations are added to the skeleton KML file. Overlays for the text annotations are added to the skeleton KML file. An image overlay for the geo-spatially enabled image is added to the skeleton KML file. The skeleton KML file and all files associated with the metadata overlays and annotations are zipped into a zipped KML (KMZ) file. The KMZ file is uploaded to a discoverable data store.

Certain embodiments of the invention may provide one or more technical advantages. A technical advantage of one embodiment may include the capability to generate fused and exploited image products. Yet other technical advantages may include the capability to disseminate fused and exploited image products in a format accessible by a variety of platforms. Yet other technical advantages may include the capability to generate fused and exploited image products that maintain pixel integrity.

Various embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 shows a system for generating fused and exploited image products according to one embodiment;

FIGS. 2A and 2B show a method of generating fused and exploited image products using the system of FIG. 1 according to one embodiment; and

FIG. 3 presents an embodiment of a general purpose computer operable to perform one or more operations of various embodiments of the invention.

### DETAILED DESCRIPTION OF THE DRAWINGS

It should be understood at the outset that, although example implementations of embodiments of the invention are illustrated below, the present invention may be implemented using any number of techniques, whether currently known or not. The present invention should in no way be limited to the example implementations, drawings, and techniques illustrated below. Additionally, the drawings are not necessarily drawn to scale.

Image systems may reference a variety of data types, such as digital-imagery products and image-related products. In one example, an image system may map digital-imagery products, such as a digital image, to image-related data, such as a map, table, annotations, or metadata, to form a fused and exploited image product. For example, a fused image product might include a digital-imagery product and associated metadata. In another example, an exploited image product might include a digital-imagery product and annotations to the digital-imagery product.

For example, an image system may use the National Imagery Transmission Format (NITF) standards. The NITF standard is a U.S. Department of Defense (DoD) and Federal Intelligence Community (IC) suite of standards for the exchange, storage, and transmission of digital-imagery products and image-related products. The NITF standards provide a package containing information about an image, the image itself, and optional overlay graphics. For example, the package may include the image, subimages, symbols, labels, and text as well as other information related to the image. NITF packages may require a commercial NITF application, such as a NITF viewer. However, a single-user NITF-viewer license may be cost-prohibitive. Additionally, NITF viewers may be cumbersome to use.

In another example, a Joint Photographic Experts Group (JPEG) file may be derived from a package, such as an NITF package. In this example, image-related products, such as subimages, symbols, labels, and text, may be “burnt in” to the JPEG image. Unlike a NITF file, a JPEG image may be viewed by a variety of image-viewing applications. However, “burning” the image-related products into the JPEG image replaces underlying image pixels with image-related product pixels, and these underlying image pixels are permanently lost.

Accordingly, teachings of certain embodiments recognize the ability to generate fused and exploited image products. Teachings of certain embodiments recognize that generated fused and exploited image products may be accessible by a variety of platforms. For example, in one embodiment, a fused image may be generated according to a markup language, such as Keyhole Markup Language (KML). KML is an XML-based language schema for expressing geographic annotation and visualization on existing or future Web-based, two-dimensional maps and three-dimensional Earth browsers. Although embodiments describing KML implementations may be described, embodiments are not limited to the KML example implementation.

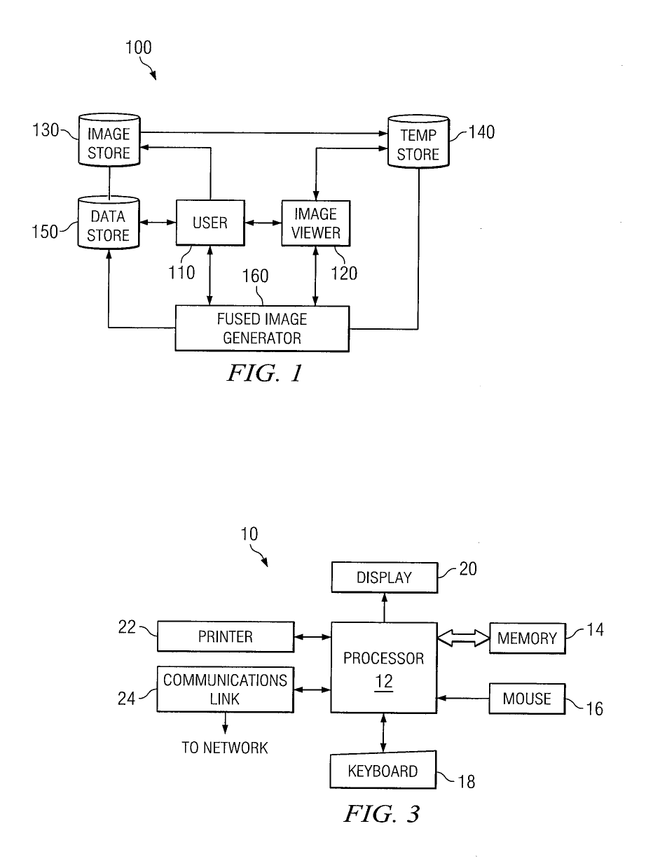

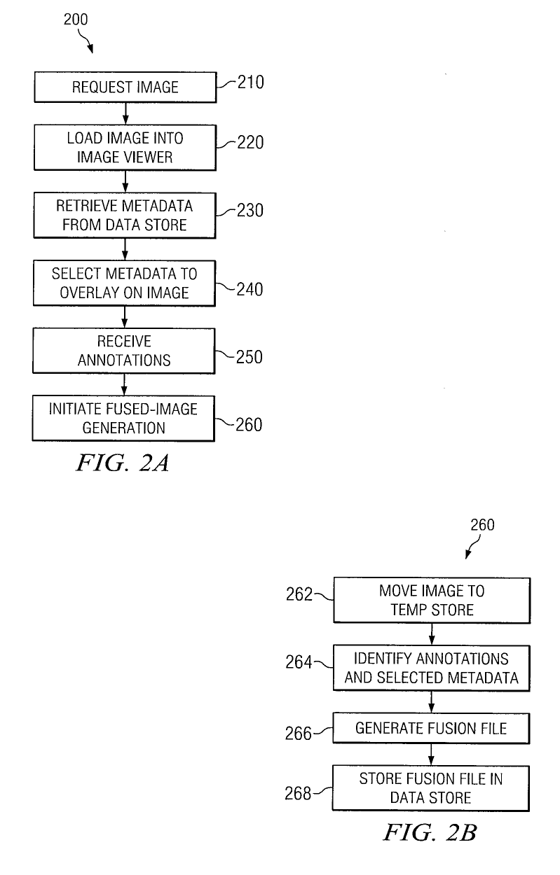

FIGS. 1, 2A, and 2B shows a system and method for generating fused and exploited image products according to one embodiment. FIG. 1 shows a system 100 featuring a user 110, an image viewer 120, an image store 130, a temporary store 140, a data store 150, and a image generator 160. The image viewer 120 may represent any suitable image viewer. The user 110, the image viewer 120, the image store 130, the temporary store 140, the data store 150, and the image generator 160 may be physically distributed, being in different locations geographically remote from one another, or logically distributed, being at approximately the same location as one another. Furthermore, although the user 110, the image viewer 120, the image store 130, the temporary store 140, the data store 150, and the image generator 160 are illustrated and primarily described as being separate, it is understood that the systems and the functionality associated with the systems may be included in a single system.

FIGS. 2A and 2B show a method 200 of generating fused and exploited image products using the system 100 of FIG. 1 according to one embodiment. At step 210, the user 110 requests an image from the image store 130. The requested image may be any suitable image. For example, in one embodiment, the image may be a geo-spatially enabled image, such as a geo-tagged Image File Format (geoTIFF) file or a NITF file. In some embodiments, the requested image may include metadata describing the image.

At step 220, the image is transmitted from the image store 130 to the temporary store 140 and loaded into the image viewer 120. For example, in one embodiment, an application associated with the image viewer 120 may detect the presence of the image at the temporary store 140 and direct the image viewer 120 to load the image.

At step 230, metadata is retrieved from the data store 150. Examples of this metadata may include, but is not limited to, subimages, symbols, labels, and text as well as other information related to the image. For example, in one embodiment, the image may display an object with an associated geo-spatial and temporal information. The metadata from the data store 150 may include geographic location information for the image, as well as other information regarding the geo-spatial and temporal information.

In some embodiments, the retrieved metadata may be incorporated into a graphical overlay. For example, in one embodiment, the metadata may include style data or standard report type data, and this metadata may be used to generate a graphical overlay over the requested image. The graphical overlay may also include any other suitable metadata. In some embodiments, the graphical overlay may include metadata such as subimages, symbols, labels, and text.

In some embodiments, the data store 150 may include a variety of types of metadata. In these embodiments, the user 110 may identify the metadata to be retrieved from the data store 150. For example, in one embodiment, the user 110 may request certain categories of metadata. In other embodiments, the data store 150 may provide available metadata, and the user 110 may determine specific metadata of interest.

At step 240, the metadata retrieved in step 230 is overlaid onto the image. For example, in one embodiment, the image may be an aerial view of a geographic location. In this example, the metadata may include the location of a point of interest near or at the geographic image. Thus, at step 240, a symbol representing the point of interest may be overlaid onto the aerial image at a point corresponding to the geographic location of the point of interest.

At step 250, annotations from the user 110 may be received. As a non-limiting example, a user 110 may add annotations using an annotation tool, such as the annotation tool of U.S. patent application Ser. No. 12/353,709, filed on Jan. 14, 2009, or any other suitable method.

In one example embodiment, the image viewer 120 may be an electronic light table. Teachings of certain embodiments recognize that an electronic light table may enable a user, such as the user 110, to “exploit” a digital image by tagging the digital image with an annotation. For example, in one embodiment, the user 110 may add text annotations to the image. In some embodiments, these annotations may describe a geographic location illustrated by the digital image; in these embodiments, the annotations may be saved and catalogued according to the described geographic location.

In addition to retrieving metadata from the data store 150, metadata may also be transmitted with the image. For example, in embodiments wherein the image is a included in a NITF file, the NITF file may have one or more headers that include metadata relating to the image, such as timestamp information, geolocation information, information related to the type of image, and information related to the platform from which the image came.

Thus, after steps 240 and 250, metadata is selected from the data store 150 and/or annotations are received from the user 110. This metadata and annotations may include information regarding the image. At step 260, this metadata and annotations may be fused to the image. In one embodiment, the user 110 may direct the image viewer 120, or an application associated with the image viewer 120, to initiate fused-image generation. Fused-image generation is described in further detail with respect to FIG. 2B.

At steps 262 and 264, the image, the selected metadata, and the annotations are moved to the temporary store 140. At step 266, the image generator 160 may generate a fusion file. For example, in one embodiment, the image generator 160 may detect image, metadata, and annotation delivery. In another embodiment, the image generator 160 may detect image delivery and then request metadata and annotation delivery.

In an example embodiment wherein the image is delivered in a NITF file, the image generator 160 may detect image delivery and extract annotations and metadata from the NITF file or from the data store 150. In this example, the image generator 160 may also request that the image viewer 120 deliver an alternative format of the image to the temporary storage 140. For example, in one embodiment, the image viewer 120 may deliver a Joint Photographic Experts Group (“JPEG”) image to the temporary storage 140. The image generator 160 may then identify selected metadata and annotations. For example, in one embodiment, the image generator 160 may identify selected metadata and annotations using an overlay “cookie” associated with each graphical overlay in the NITF file.

One example of a fused image file generated at step 266 may include a KML file. For example, in one embodiment, the image generator 160 may create a skeleton KML file, add separate overlays for each type of metadata and annotations, add a separate overlay for associated JPEG images, and store the KML file in temporary storage. In this embodiment, the image generator 160 may then marshal all associated files, such as any JPEG images and metadata and annotation entries, and zip the associated files into a single archive file, such as a zipped KML file (“KMZ”).

At step 268, the image generator 160 stores the fusion file in a data store. For example, in one embodiment, the image generator 160 may store the fusion file in the data store 150. In some embodiments, the data store 150 may catalog the fusion files and make it available to any user with access to the data store 150. For example, in embodiments wherein the fusion file is a KMZ file, the data store 150 may catalog the KMZ file in a discoverable datastore with other KMZ files. Teachings of certain embodiments recognize that KMZ files stored in a data store may be discovered and accessed by an existing or future Web-based or stand-alone, two-dimensional map and three-dimensional Earth browsers or other capable viewers, whether that capability is native or extensible.

FIG. 3 presents an embodiment of a general purpose computer 10 operable to perform one or more operations of various embodiments of the invention. The general purpose computer 10 may generally be adapted to execute any of the well-known OS2, UNIX, Mac-OS, Linux, Android, and Windows Operating Systems or other operating systems. The general purpose computer 10 in this embodiment comprises a processor 12, a memory 14, a mouse 16, a keyboard 18, and input/output devices such as a display 20, a printer 22, and a communications link 24. In other embodiments, the general purpose computer 10 may include more, less, or other component parts.

Several embodiments may include logic contained within a medium. Logic may include hardware, software, and/or other logic. Logic may be encoded in one or more tangible media and may perform operations when executed by a computer. Certain logic, such as the processor 12, may manage the operation of the general purpose computer 10. Examples of the processor 12 include one or more microprocessors, one or more applications, and/or other logic. Certain logic may include a computer program, software, computer executable instructions, and/or instructions capable being executed by the general purpose computer 10. In particular embodiments, the operations of the embodiments may be performed by one or more computer readable media storing, embodied with, and/or encoded with a computer program and/or having a stored and/or an encoded computer program. The logic may also be embedded within any other suitable medium without departing from the scope of the invention.

The logic may be stored on a medium such as the memory 14. The memory 14 may comprise one or more tangible, computer-readable, and/or computer-executable storage medium. Examples of the memory 14 include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or other computer-readable medium.

The communications link 24 may be connected to a computer network or a variety of other communicative platforms including, but not limited to, a public or private data network; a local area network (LAN); a metropolitan area network (MAN); a wide area network (WAN); a wireline or wireless network; a local, regional, or global communication network; an optical network; a satellite network; an enterprise intranet; other suitable communication links; or any combination of the preceding.

Although the illustrated embodiment provides one embodiment of a computer that may be used with other embodiments of the invention, such other embodiments may additionally utilize computers other than general purpose computers as well as general purpose computers without conventional operating systems. Additionally, embodiments of the invention may also employ multiple general purpose computers 10 or other computers networked together in a computer network. For example, multiple general purpose computers 10 or other computers may be networked through the Internet and/or in a client server network. Embodiments of the invention may also be used with a combination of separate computer networks each linked together by a private or a public network.

Modifications, additions, or omissions may be made to the systems and apparatuses described herein without departing from the scope of the invention. The components of the systems and apparatuses may be integrated or separated. Moreover, the operations of the systems and apparatuses may be performed by more, fewer, or other components. The methods may include more, fewer, or other steps. Additionally, steps may be performed in any suitable order. Additionally, operations of the systems and apparatuses may be performed using any suitable logic. As used in this document, “each” refers to each member of a set or each member of a subset of a set.

Although several embodiments have been illustrated and described in detail, it will be recognized that substitutions and alterations are possible without departing from the spirit and scope of the present invention, as defined by the appended claims.

To aid the Patent Office, and any readers of any patent issued on this application in interpreting the claims appended hereto, applicants wish to note that they do not intend any of the appended claims to invoke paragraph 6 of 35 U.S.C. § 112 as it exists on the date of filing hereof unless the words “means for” or “step for” are explicitly used in the particular claim.

What is claimed is:

1. A computer-readable medium having computer-executable instructions, when executed by a computer configured to:
request a National Imagery Transmission Format (NITF) file, the NITF file comprising a geo-spatially enabled image, associated metadata, and text annotations,
retrieve a plurality of graphical overlays from a metadata repository, the plurality of graphical overlays comprising additional metadata associated with the geo-spatially enabled image;
extract the text annotations from the geo-spatially enabled image;
create a skeleton Keyhole Markup Language (KML) file;
add metadata overlays for each type of metadata and text annotations to the skeleton KML file;
adding overlays for the text annotations to the skeleton KML file;
add an image overlay for the geo-spatially enabled image to the skeleton KML file;
zip the skeleton KML file and all files associated with the metadata overlays and annotations into a zipped KML (KMZ) file; and
upload the KMZ file to a discoverable data store.

2. The computer-readable medium of claim 1, wherein the geo-spatially enabled image illustrates a geographic location, the text annotations providing information regarding the geographic location.

3. A computer-readable medium having computer-executable instructions, when executed by a computer configured to:
receive a geo-spatially enabled image;
retrieve a plurality of graphical overlays from a metadata repository, the plurality of graphical overlays comprising metadata associated with the geo-spatially enabled image;
generate a fusion file from the geo-spatially enabled image and the metadata; and
store the fusion file in a data store.

4. The computer-readable medium of claim 3, wherein the geo-spatially enabled image is a National Imagery Transmission Format (NITF) image.

5. The computer-readable medium of claim 3, the computer-executable instructions further configured to receive a geo-spatially enabled image by:
requesting a digital image; and
loading the digital image into an image viewer.

6. The computer-readable medium of claim 5, the computer-executable instructions further configured to identify the metadata by receiving user selections, the user selections selecting one or more metadata from the metadata repository.

7. The computer-readable medium of claim 3, the computer-executable instructions further configured to:
receive annotations to the geo-spatially enabled image; and
incorporate the annotations into the fusion file.

8. The computer-readable medium of claim 7, the computer-executable instructions further configured to receive annotations to the geo-spatially enabled image by receiving user annotations, the user annotations tagging the geo-spatially enabled image with the annotations.

9. The computer-readable medium of claim 7, wherein the geo-spatially enabled image shows a geographic location, the annotations providing information regarding the geographic location.

10. The computer-readable medium of claim 7, wherein the annotations are text annotations.

11. The computer-readable medium of claim 3, wherein the fusion file is a Keyhole Markup Language (KML) file.

12. The computer-readable medium of claim 11, the computer-executable instructions further configured to generate a fusion file from the geo-spatially enabled image by:
creating a skeleton KML file;
adding the metadata from the plurality of graphical overlays to the skeleton KML file;
adding overlays for one or more annotations to the skeleton KML file;
adding an image overlay for the geo-spatially enabled image to the skeleton KML file; and
zipping the skeleton KML file and all files associated with the plurality of graphical overlays into a zipped KML (KMZ) file.

13. A method for generating fused and exploited image products, comprising:
using a computer system, receiving a geo-spatially enabled image;
using a computer system, retrieving a plurality of graphical overlays from a metadata repository, the plurality of graphical overlays comprising metadata associated with the geo-spatially enabled image;
using a computer system, generating a fusion file from the geo-spatially enabled image and the metadata; and
using a computer system, storing the fusion file in a data store.

14. The method of claim 13, wherein the geo-spatially enabled image is a National Imagery Transmission Format (NITF) image.

15. The method of claim 13, the receiving a geo-spatially enabled image further comprising:
requesting a digital image; and
loading the digital image into an image viewer.

16. The method of claim 13, further comprising receiving user selections, the user selections selecting one or more metadata from the metadata repository.

17. The method of claim 13, further comprising:
receiving annotations to the geo-spatially enabled image; and
incorporating the annotations to the fusion file.

18. The method of claim 17, the receiving annotations to the geo-spatially enabled further comprising receiving user annotations, the user annotations tagging the geo-spatially enabled with the annotations.

19. The method of claim 17, the geo-spatially enabled showing a geographic location, the annotations providing information regarding the geographic location.

20. The method of claim 17, wherein the annotations are text annotations.

21. The method of claim 13, wherein the fusion file is a Keyhole Markup Language (KML) file.

22. The method of claim 21, the generating a fusion file further comprising:
creating a skeleton KML file;
adding the metadata from the plurality of graphical overlays to the skeleton KML file;
adding overlays for one or more annotations to the skeleton KML file;
adding an image overlay for the digital image to the skeleton KML file; and
zipping the skeleton KML file and all files associated with the metadata overlays and annotation into a zipped KML (KMZ) file.
